(19) United States
(12) Patent Application Publication
(10) Pub. No.: US 2009/0173401 A1
(43) Pub. Date: Jul. 9, 2009

(54) VALVE ASSEMBLY

(76) Inventor: Murray Andrew Hodges, Victoria (AU)

Correspondence Address: SUGHRUE MION, PLLC, 2100 PENNSYLVANIA AVENUE, N.W., SUITE 800, WASHINGTON, DC, 20037, US

(21) Appl. No.: 12/296,069

(22) PCT Filed: Apr. 3, 2007
(86) PCT No.: PCT/AU2007/000432

§ 371 Date: Jan. 9, 2009

(30) Foreign Application Priority Data
Apr. 3, 2006 (AU) 2006901712

(51) Int. Cl. F16K 15/00

(52) U.S. Cl. 137/528; 251/324

(57) ABSTRACT

A valve comprising a body portion, a closure portion adapted to control the flow of fluid through the body portion, and a valve element being at least disposed between the closure portion and the body portion. The invention extends to other arrangements detailed herein.

### FIELD OF INVENTION

The present invention relates to valves and in preferred arrangements relates to piston operated check valves.

It will be convenient to hereinafter describe the invention in relation to poppet type valves, however it should be appreciated that the present invention is not limited to only these types of valves and that other types of valves may be used.

The application claims priority from Australian Provisional Application 2006901717 entitled “Valve Assembly” and filed 3 Apr. 2006, the entire disclosure of which is hereby fully incorporated by reference.

### BACKGROUND ART

The discussion throughout this specification comes about due to the realisation of the inventors and/or the identification of certain prior art problems by the inventors.

The failure of safety related components of fluid power control systems can potentially expose operators and other persons to the risk of serious injury or death. To attend to the reduction of these risks various safety regulations and equipment have been in place.

There is a continual need to be able to both meet safety regulations and, moreover, provide adequate protection with reliable and well engineered systems.

For example, in iron rolling systems and the like, monitored valves are used as part of the safety functionality of fluid power control systems. Safety standards such as safety standards EN292-1, EN292-2, EN1050 and EN954-1 provide safety design considerations for parts of control systems.

It would be advantageous if parts of control systems could be designed to meet first, second and third tier stands to provide safety integrity. Furthermore, in considering failure modes, when analysing a safety system, it is desirable to control movement of parts such that events only occur when predetermined conditions are met.

In this respect it would be advantageous to provide increased confidence of any fault notification such as those which can result from partial operation from sticking components or contamination.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

In the context of the present invention, it is to be taken that the term “fluid” applies to any material that displays fluid like behaviour, such as liquids, gases and slurries.

It is an object of the invention is to alleviate at least one disadvantage associated with the prior art, or at least provide the public with a useful choice.

### SUMMARY OF INVENTION

According to a first aspect of embodiments described herein there is provided a valve comprising: a body portion, a closure portion adapted to control the flow of fluid through the body portion, and a valve element being disposed proximate the closure portion and the body portion.

Preferably, the valve element is associated with the valve body portion. The valve element may be associated with a movable portion of the valve. The valve element may be associated with a head of the valve. The valve is preferably a check valve having a poppet structure. Furthermore, the valve preferably provides for deadband travel and the valve element preferably has a dimension that substantially defines the amount of deadband travel provided by the valve. In a further preferred embodiment, the closure portion comprises a poppet valve. The valve may be a spool valve. The dimension may be the thickness of the valve element proximate the closure portion. The closure portion comprises a closure element adapted to provide a relative sealing engagement with the valve element at least during deadband travel of the valve

According to a second aspect of embodiments described herein there is provided a valve comprising a valve closure element, and a body having a port, the valve closure element being moveable between two positions relative to the body, and the body providing for a degree of movement of the valve closure element from one of the two positions towards the other of the two positions before fluid readily flows through the port.

Preferably the body provides for the degree of movement before fluid is able to flow through the port. In this regard it is to be appreciated that some embodiments may indeed accommodate some leakage flow. It is to be appreciated that the body provides for the degree of movement on interaction with the valve closure element.

According to a third aspect of embodiments described herein there is provided a valve assembly comprising a valve closure element, and a body defining a passage having a longitudinal axis and a port in line therewith, the valve closure element being moveable along the longitudinal axis of the passage, between a first and a second position to selectively allow fluid to flow through the port, and the body providing a degree of movement of the valve element from the first position towards the second position before fluid readily flows through the port.

Preferably the valve assembly includes a switch associated with the valve closure element and which is adapted to make use of the degree of movement of the valve element from the first position towards the second position before fluid readily flows through the port. Preferably the closure element compensates for the switch, where the switch has a sensitivity that is unable to detect a substantial portion of the degree of movement.

In particular forms of the invention the port is preferably a continuation of the longitudinal extent of the passage and is configured to sealingly engage with the closure element when in the first position. The port may define a narrowing of the passage and may include side walls configured for hydrostatic sealing.

According to a fourth aspect of embodiments described herein there is provided a valve accessory adapted to enable limited deadband travel in a valve, the valve having a mount portion and a body portion, the valve accessory comprising: a first portion adapted to cooperate with the mount portion, a second portion adapted to cooperate with the body portion, the valve accessory being further adapted to be located between the body portion and the mount portion.

Preferably, the valve accessory further comprises a third portion adapted to cooperate with a closure element of the valve. The third portion may be dimensioned to substantially define the distance of dead band travel.

According to a fifth aspect of embodiments described herein there is provided a valve accessory adapted to enable limited deadband travel in a valve, the valve having a body portion, the valve accessory comprising a first portion adapted to engage an end of the body portion defining a port thereof for cooperating with a closure element of the valve.

Preferably, the valve accessory includes a fluid port for configured to sealing engage the closure element of the valve. The fluid port may be configured for hydrostatic sealing substantially in the order of one tenth of a thousandth. The fluid port may be configured for hydrostatic sealing of about one tenth of a thousandth. Furthermore, a seal may be provided between the first portion of valve accessory and the body portion.

According to a sixth aspect of embodiments described herein there is provided a method of configuring a valve assembly to enable deadband travel, the method comprising the steps of: providing a valve element, associating the valve element with a portion of the valve, proximate a valve port in a manner which results in a relative thickening of the portion of the valve.

Preferably, the portion of the valve is the valve head. In another embodiment, the portion of the valve is the valve body.

According to a seventh aspect of embodiments described herein there is provided a safety method including using deadband travel in a safety system to ensure that a switch is able to safely determine at least one operating condition.

According to an eighth aspect of embodiments described herein there is provided a valve comprising a body having a first portion for seating against a fluid port and second portion for being received within the fluid port, when the seat portion is seated against the fluid port, the second portion being configured for providing for dead band travel when the first potion is moved away from the fluid port. The valve may be a poppet valve.

According to a ninth aspect of embodiments described herein there is provided a method of configuring a safety valve assembly adapted to be associated with a fluid flow path, the method comprising the steps of configuring at least one valve as disclosed herein, and operatively coupling at least one of the at least one valves to a switch and a switch actuator.

Preferably, activation of the switch by the switch actuator may be provided prior to flow of fluid in the fluid path.

With arrangements of the present invention the output of the monitoring function of safety devices can be more tightly controlled in that there is provided an amount of dead band travel that can be used to accommodate tolerances of say a connected switch. When a check valve is near the fully closed condition this will accordingly be able to be sufficiently safely recognised by the switch with a particular amount of certainty.

In essence, the present invention comes about due to the realisation that deadband travel and its associated safety, additional fluid seal, fluid control and operational advantages can be provided in a number of different valve arrangements by the addition of a valve element and/or by a thickening of the valve body proximate the valve port. The valve element and/or the thickening may be used depending on the particular valve arrangement to which this invention is applied.

Advantageously the invention also provides a system comprising a valve in accordance with the above aspects in combination with a two spool valve monitoring apparatus as disclosed in PCT application PCT/AU02/00093 filed on 2 Jul. 2002 and published as WO 03/004194. The use of the check valve improves the sensing range in the system as a whole and reduces ambiguity of the absolute ‘off’ position.

In summary advantages of arrangements of the invention include:
advantageously accommodating tolerances in monitoring switches
determining operating conditions with increased confidence levels
advantageously providing systems having increased confidence of any fault notification
advantageously confirming safety functions have been achieved prior to exposure of dangerous machines to operators
providing improved systems for hydraulic load holding functions

Other aspects and preferred aspects are disclosed in the specification and/or defined in the appended claims, forming a part of the description of the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative of the present invention, and in which:

FIG. 1 illustrates a valve according to a first preferred embodiment of the present invention;

FIGS. 2a, 2b and 2c illustrate valves according to further preferred embodiments of the present invention.

FIG. 3 illustrates a valve assembly according to another preferred embodiment of the invention;

FIG. 4 illustrates a variation of the valve assembly shown in FIG. 3.

FIG. 5 illustrates a safety system according to another preferred embodiment of the invention;

FIG. 6 illustrates a further safety system according to yet another preferred embodiment of the invention;

FIG. 7 illustrates a first control system according to another preferred embodiment of the present invention;

FIGS. 8 and 9 illustrate further control systems according to further preferred embodiments of the present invention; and

FIG. 10 illustrates a third control system according to yet another preferred embodiment of the present invention.

### DETAILED DESCRIPTION

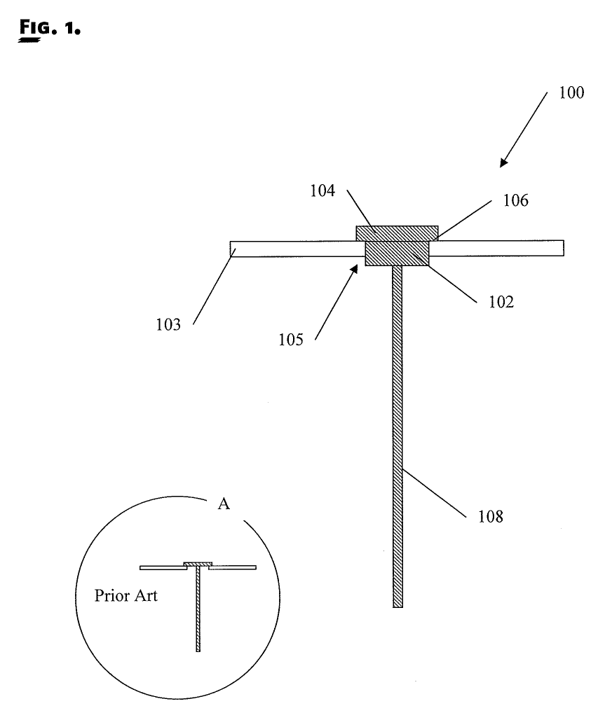

Referring to FIG. 1 there is shown a poppet valve 100 according to a preferred embodiment of the present invention. The poppet valve 100 includes a valve closure element 102 for providing deadband travel and a portion 104 for seating against a port 105. In comparison to the prior art shown in the encircled section marked “A”, in the drawings, the advantage provided by valve 100 is that the valve is able to be disposed away from its seated position, in which the valve 100 is seated against port 105 without problematic fluid flow.

Whilst the element 102 may have a depth of between 0.5 mm and 5 mm, depending on the application, the safety margin required for most applications will only safely allow for the valve to be disposed away from the port 105 by a portion of the total depth of the portion 102 in which there is minimal problematic fluid flow around the valve. The depth is of course the depth in the direction of the longitudinal axis of the stem 108 of the valve 100.

Thus it will be seen that there is provided a valve 100 comprising a valve closure element 102. There is an element 103 that provides a port 105. The valve closure element 102 is moveable between two positions relative to the port 105. The port 105 together with the element 102 provides for a degree of movement of the valve closure element 102 away from a seated position in which the portion 104 bears against the upper surface 106 of the port 105, towards a second position away from the port 105, before fluid readily flows through the port.

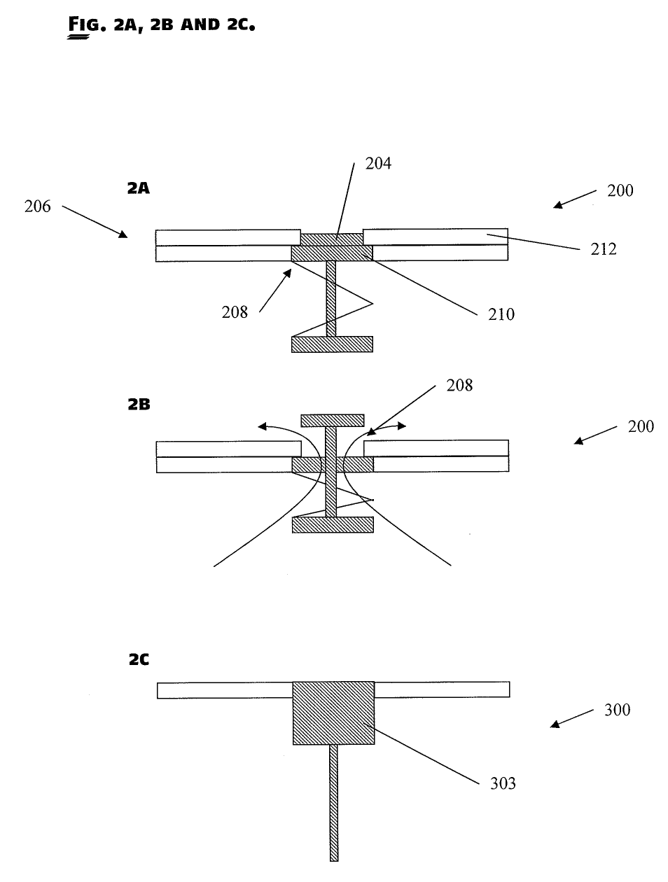

Referring to FIGS. 2a, 2b and 2c there is shown a check valve 200 according to a second preferred embodiment of the present invention. The check valve 200 comprises a valve closure element 204, and a body 206 having a port 208. The valve closure element 204 is moveable between a first position in which the valve closure element 204 is seated against a lower portion 210 of the check valve 200 and a second position in which the valve closure element 22 and lower portion 210 are separated.

The body 206 by virtue of collar 212 provides for a degree of movement of the valve closure element 204 before fluid readily flows through the port 208. The first position is illustrated in FIG. 2a and the second position is illustrated in FIG. 2b. FIG. 2c shows a valve arrangement 300 according to another preferred embodiment that provides for substantial deadband travel defined primarily by the depth of valve closure element 303.

Although not shown in the drawings each of the valves are connected to a monitoring switch that determines whether the valve is in a normally closed condition. If the valve is in the deadband travel region then the monitoring switch provides a condition that results in an alert signal.

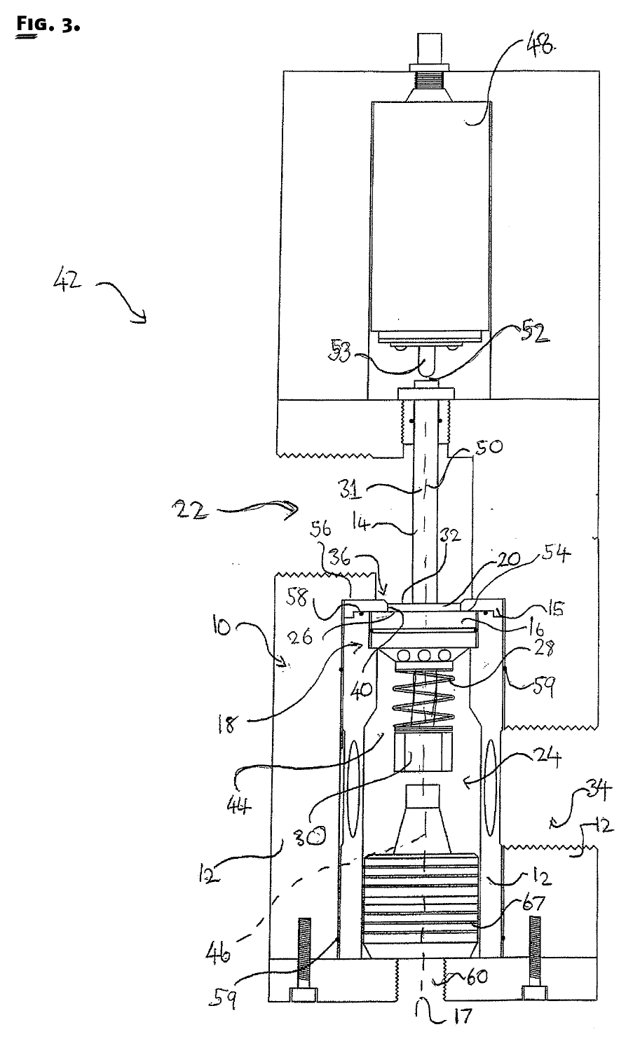

Referring to FIG. 3 there is shown a valve 10 comprising a body portion 12 and a closure portion 14 adapted to control the flow of fluid through the body portion 12. As is apparent from FIG. 3 there is further provided a valve element 15 disposed between the closure portion 14 and the body portion 12 along the longitudinal axis 17 of the valve 10.

In this arrangement the valve 10 comprises a check valve that allows for reverse flow in a safety system involving a hydraulic press.

As would be apparent the valve 10 is a pilot operated check valve consisting of a closure portion 14 in the form of a poppet. The closure portion 14 includes a mount portion 16 that is located in recess 18 in the body portion 12 of the valve 10. The closure portion 14 further includes a closure element 20 in the form of the head of the poppet. The closure element 20 is adapted to move away from the mount portion 16 to allow fluid under pressure at 2000 psi to flow though the mount portion 16 into the region 22 to supply the hydraulic press (not shown). In this embodiment possible fluid pressures may range to about 5000 psi.

In the case of reverse flow from region 22 into the region 24, below the mount portion 16, the closure element 20 will be held against a seat 26 of the mount portion 16 and will be assisted by the biasing action of the a spring 28 forming part of the closure portion 14.

The spring 28 extends between a nut element 30 of the closure portion 14 positioned at a lower end of an actuating arm 31 of the closure portion 14.

In FIG. 3 the valve 10 is shown in a closed condition in which pressure acting on an upper surface 32 of the closure element 22 is sufficient in combination with the assistance of the spring 28 to prevent reverse flow.

When fluid in region 34 is urged in a forward direction towards region 22 pressure in the region 24 will cause the closure element 20 to move away from the seat 26 to overcome the pressure in region 22 operating over the area of the upper surface 32 of the closure element 20 and the bias of the spring. Free forward flow will result.

The valve element 15, when viewed as comprising part of the body 12, provides the body 12 with circular port 36 (which can be viewed as forming part of a larger port 36) for allowing the flow of operating fluid therethrough.

Advantageously the valve element 15 is shaped to substantially define the amount of deadband travel of the closure element 20 before fluid is able to flow through the port 36, through the valve 10.

In this embodiment the closure element 20 is adapted to provide a hydrostatic sealing engagement with the valve element 15 during the deadband travel. The valve element 15 provides an abutment 38 having side walls 40 defining the port 36.

The dimensions of the side walls 40 comprise the dimension of the thickness of the valve element 15 proximate the closure portion 14 and the closure element 20.

These dimensions advantageously provide approximately 1.2 mm deadband travel from a first position with the closure element 20 seated on the mounting portion 16 towards a second position in which the closure element 20 is spaced apart from the mounting portion 16 to allow flow. Such a position would be evident to a person skilled in the art.

Thus the valve 10 can be seen as including a valve closure element 20 and a housing 12 defining a port 36. The valve closure element is moveable between a first and a second position relative to the housing 12, and the housing 12 provides for degree of movement of the valve closure element 20 comprising 1.2 mm from a lower one of the two positions towards an upper one of the two positions before fluid is able to flow through the port 36. Various other preferred embodiments of the invention also comprise this general form. In other embodiments the deadband travel provided may be between 0.5 mm to 5 mm. The particular amount of deadband travel will depend on both the type of valve used and the application.

The valve 10 forms part of a valve assembly 42 in which the body 12 can be seen as defining a passage 44 defining the longitudinal axis 17 with the port 36 aligned therewith and extending therealong. As previously described the valve closure element 20 is moveable between a first and a second position to selectively allow fluid to flow through the port 36. This movement is directed along the longitudinal axis of the passage 44.

Advantageously and as previously described the body provides a degree of movement of the valve closure element 20 from the first position towards the second position before fluid is able to flow through the port 36.

The valve assembly 42 includes a monitoring switch 48 of the plunger type coupled to the valve closure portion 14 by lying thereabove in-line with the longitudinal axis 17 such that movement of the closure element 20 to the second position is transferred by the actuating arm 31 to a plunger 53 of the switch 48. The switch 48 is configured to be able to determine if the closure portion 14 moves through the deadband travel to the open condition and also when the port 36 is fully closed. The provision of the deadband travel allows for tolerances within the inner workings of the switch 48 and tolerances external thereto to not adversely affect the safety characteristics of the valve assembly 42 and the safety system in which the valve assembly 42 operates. This improves the operation of the system as a whole.

As is apparent from FIG. 3 the port 36 forms a part of and a continuation of the longitudinal extent of the passage 44. The port 36 can clearly be seen as forming part of the housing of the valve assembly 42. The port 36 comprises a narrowing of the passage 44 and the walls 40 are configured for hydrostatically sealing against the closure element 20. The walls 40 and the closure element 20 are precision ground and hardened for this purpose. Methods of precision grinding and hardening for hydrostatic sealing are known.

The valve assembly 42 further includes a pilot port 60 in communication with a pilot piston 66. The pilot piston 66 includes hydrostatic sealing grooves 65. In order for reverse flow to occur the pilot port 60 communicates with the pilot piston 66 to move the pilot piston 66 upwardly to contact the nut element 30 and force the rod like actuating arm 31 upwardly and move the valve closure element away from the seat 36. This allows reverse flow in the opposite direction to the free flow direction from the region 34 to the region 22. The switch 48 in combination with the deadband travel is able to advantageously determine several operating conditions.

Primarily, the function of the assembly 42 is for the monitoring switch 48 to detect a condition where the closure element 20 does not fully seat home within the 1.2 mm range. Thus, in this arrangement, if the closure element 20 is say only 0.1 or 0.2 mm away from the first position in which it is seated upon the seat 26, and the monitoring switch 48 does not detect this condition, then hydrostatic sealing will still create the safe function and thereby provide the system with an increased confidence safety range. Advantageously this safety range does not require a monitoring switch of an exceedingly high precision.

In this embodiment the distance of travel for hydrostatic sealing is 2.5 mm but after 1.2 mm of travel the leakage becomes excessive. The system is designed such that by this time the monitoring switch 48 has had ample travel to actuate. This travel distance can be extended or reduced as best seen fit. Advantageously the distance required for the monitoring switch activation is between 30% and 70% of the hydrostatic sealing distance.

Although other arrangements are possible, hydrostatic sealing in this embodiment is advantageously provided by a single groove approximately 2 thousands of an inch deep around the outer face of the closure element 20, the oil rotates in this groove therefore creating a barrier to oil passing over the groove. The use of a single groove is advantageous and the operation of the check valve only requires 7 psi for operation and the unit will operate at any pressure up to 5000 psi.

It is to be appreciated that the valve element 15 itself forms a preferred embodiment of the invention. The valve element 15 is adapted to enable limited deadband travel in the valve 10 where the valve 10 has a mount portion 16 and a body portion 12. A first portion 54 of the valve element 15 is adapted to cooperate with the mount portion 16 and a second portion 56 is adapted to cooperate with the remainder of the body portion 12. The portion of the body portion 12 that cooperates with the valve element 15 serves to compress the valve element 15 downwardly whereby an o-ring 58 forms a seal against leakage into region 22. Two other o-rings 59 form another seal arrangement preventing leakage around the casing of the valve into region 22.

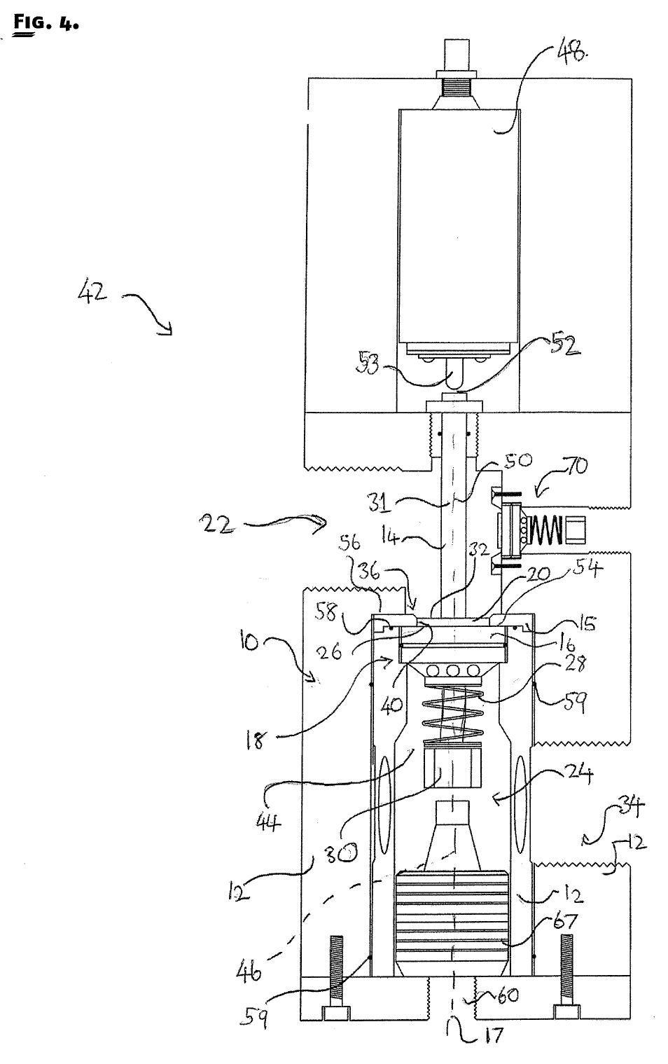

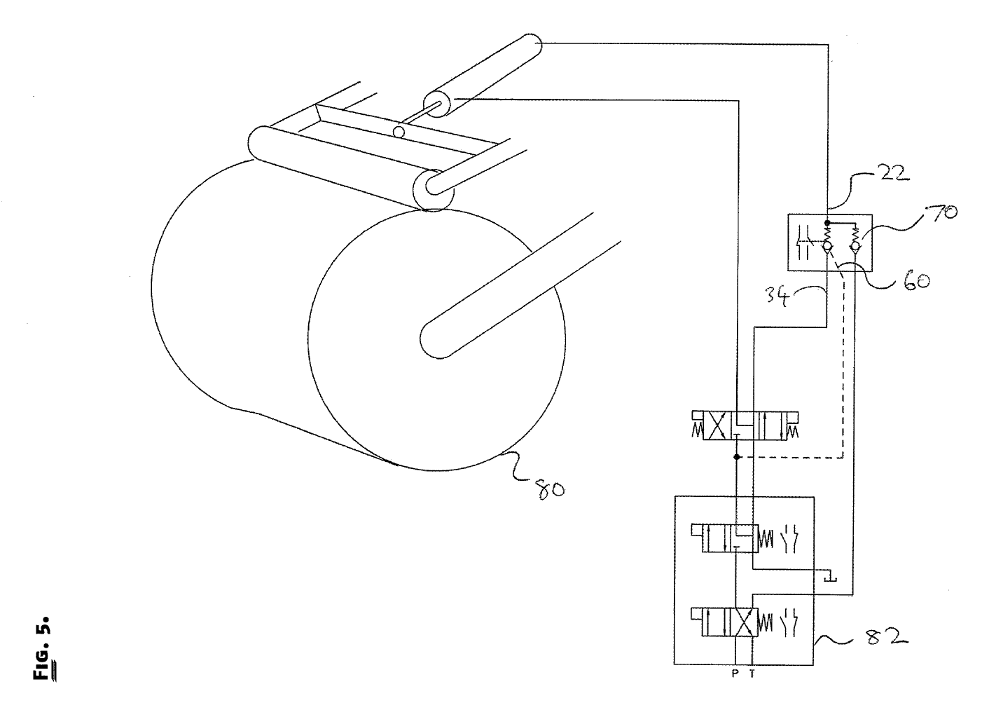

In FIG. 4 an embodiment of the valve assembly 42 is shown as including an advantageous control point 70 that provides for advantageous safety arrangements as shown in FIG. 5. FIG. 5 shows a hydraulic press 80 arrangement in which an embodiment of the invention includes a component 82 making use of a safety arrangement according to PCT application PCT/AU02/00093 filed on 2 Jul. 2002 and published as WO 03/004194.

The press 80 shown in FIG. 5 comprises a recoiler or uncoiler, as is utilized in the steel, aluminium and paper industries. Of particular concern with these devices is that if the coil is out of round and the roll rotates this could relieve pressure on the roll and permit the roll to uncoil itself.

The monitored pilot operated check valve arrangement 82 in combination with the secondary check valve will hold pressure on the roll at all times and the overall safety system will detect any failures. This is advantageous and can also be interlocked into guard and gate circuits to prevent operator access should there be a component failure and the safety function not be achieved.

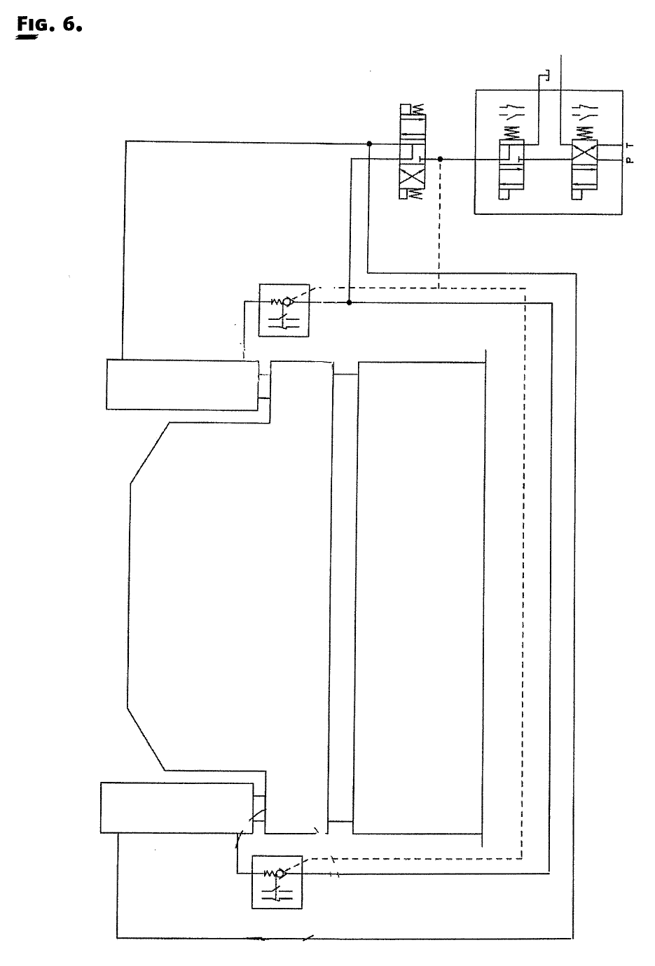

Another arrangement is shown in FIG. 6. In this arrangement a hydraulic press with a monitored pilot operated check valve hold the hydraulic cylinders in position while an operator accesses the machine. This is another advantageous arrangement.

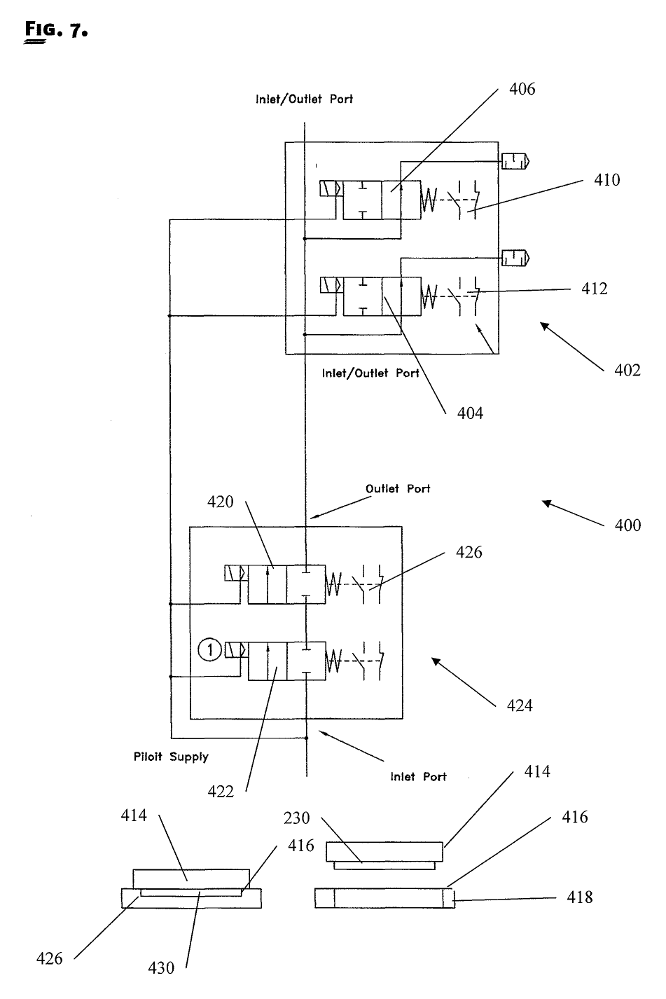

Referring to FIG. 7 there is shown a system 400 according to another preferred embodiment of the present invention. The system 400 includes an exhaust module 402 having two normally open valves 404 and 406. With respect to each normally open valve 404, 406 there is provided a monitoring switch 410, 412. The monitoring switches 410 and 412 are of the safety type, mechanically linked having positive opening switch contacts. The valves 404 and 406 include valve closures 414 having seats 416 defined by fluid ports. The system 400 includes two normally closed valves 420, 422 providing a supply module 424. In comparison to valves 404 and 406, the valves 420 and 422 are normally closed which means that the closures 414 thereof are normally positioned against seats 416 of the ports on their outer faces. With a depth 426 of 2 mm this means that the valves 404 and 406 can be, say 1 mm away from their seated condition while providing a safe but failed condition. The positioning of the valves 420 and 422 away from their seats 416 would be detected by monitoring switches 426 and 428 to alert the user. The portion 430 on the valves 420 and 422 can be thought of as nose that permits switching of the monitoring contact prior to full travel to the home position.

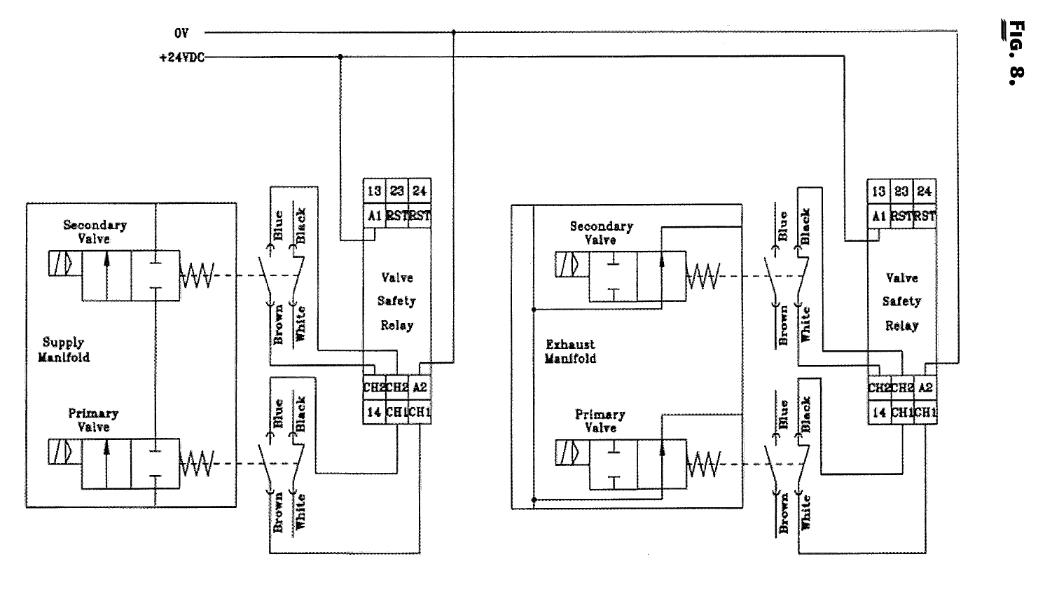

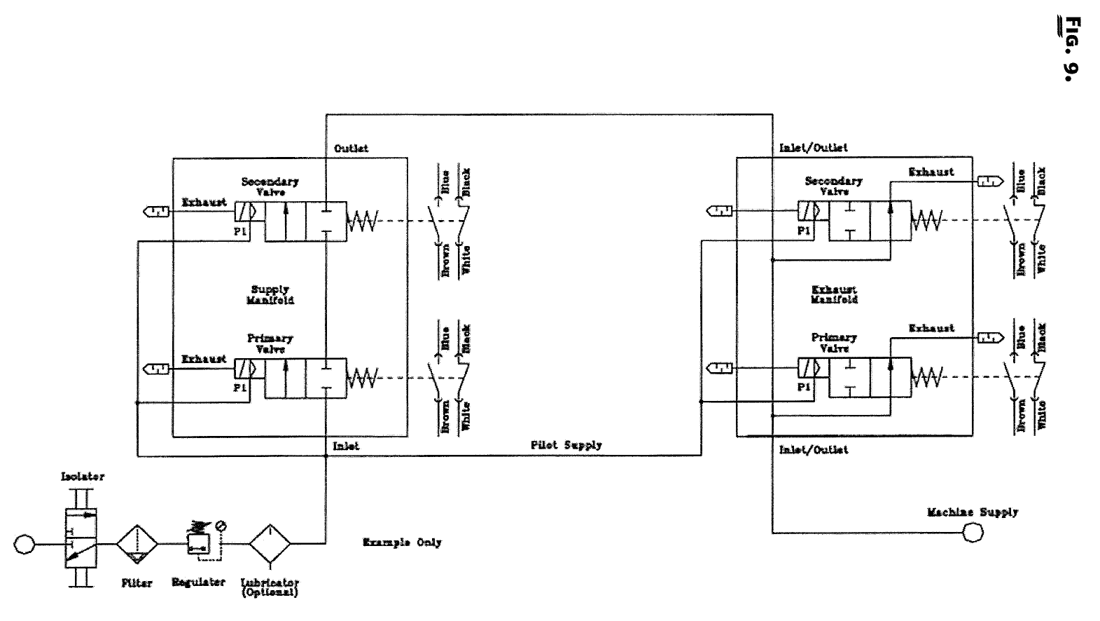

FIG. 8 shows an electrical interfacing locking system and FIG. 9 shows a pneumatic connection for directional control valves for pneumatic safety applications in two port two position poppet type valves mounted on two independent safety manifolds configured for three port two position operation.

Each valve in the system incorporates a two pole positive driven plunger type switch with positive opening contact. The two models offered have certification. Valves are supplied with 24 VDC solenoid coils as standard. The system is suitable for risk category 4 applications as per EN 954-1 & AS4024.1. Applications Include: pneumatic presses, palletising equipment pneumatic pushers & ejectors, pneumatic guillotines packaging machinery guard access preconditions, automated fixtures robot & automated cells process control & monitoring and so forth. A dual series ported supply manifold PBV-614A-40A-2M is suitable for risk category 4 applications and a dual parallel ported exhaust manifold PBV-612A-40A-2M is suitable for Risk Category 2&4 applications. The materials comprise: main body, extension housing: aluminium; pilot housing: plastic; poppet: bronze; return spring: steel; seals: NBR; screws: cap screws; lubricant: diamond grease; switch-make: Bernstein; model: 188-U1Z w (608.6103.008); type: Plunger; approvals: EN 1088, EN 60947-5-1, EN 292, EN 60204-1; contacts: 1× Normally Closed (Safety Contact) 1× Normally Open (Non Safe Contact); wiring: Switch Terminals: 11-12 White-Black (NC), 21-22 Brown-blue (NO); coil: Voltages available: 240 vac, 110 vac, 24 vac, 24 vdc, 12 vdc; power Consumption DC: 4.8 W; features: Indicator light and surge suppression; allowable Voltage: −5% to +10% Rated Voltage; apparent power: Inrush: 12 VA/50 Hz 10.5 VA/60 Hz; holding: 7.5 VA 50 Hz, 6 VA 60 Hz; plug Wiring: Pin 1: Positive/Active; pin 3: Negative/Neutral; Earth: Earth; performance: valve working pressure range: 250-1000 kPa; port connection: 1½″ BSP; pilot port connection: ¼″ BSP; medium: compressed air filtered to 5 micron and/or lubricated; operating temperature range: Max −5 to 60 Celsius; Cv (flow factor) Supply Module Cv18, Exhaust Module Cv50; maximum operating frequency: 5 Hz; activation time: TBA Milliseconds; Deactivation time: TBA Milliseconds; Rating: Protection: IP 65; approvals: Machinery Directives: 98/37/EC-EN 292-1, EN 292-2, EN 983, EN 954-1, EN 1050; Manual: Manual Override: Disabled Internally Silencers: Pilot Exhaust: ¼″ BSP SMC Part No: AN203-02; Main Exhaust: 1½″ BSP SMC Part No: AN800-14.

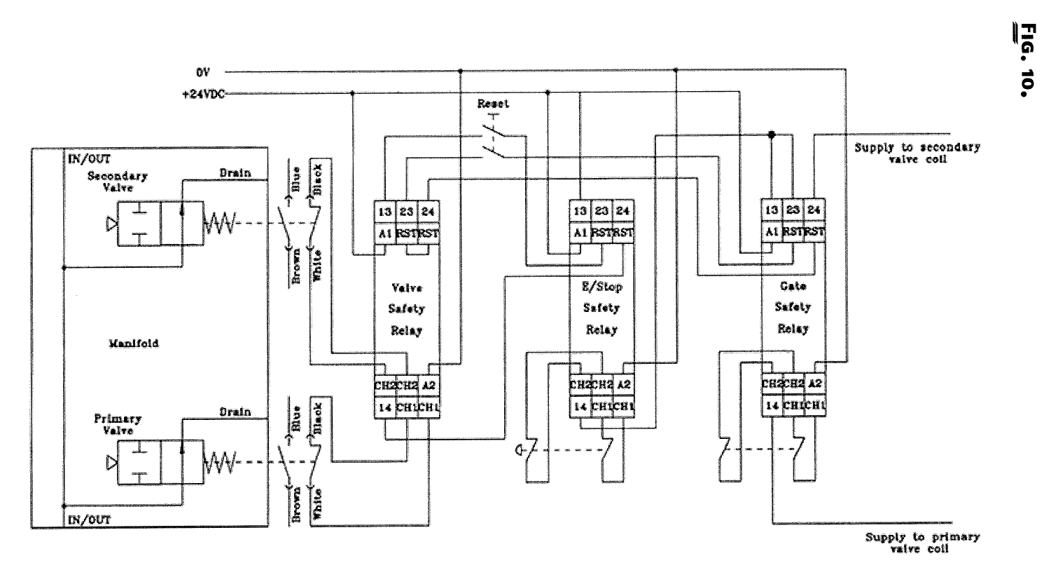

FIG. 10 shows specifications for another preferred embodiment of the invention. In the embodiment there is provided a monitored plunger type drain valve for fluid applications in parallel two-port-two position normally open configuration, mounted on a parallel ported safety manifold. Each valve incorporates a two-pole positive driven plunger type switch with positive opening contact. The product has been designed and tested to meet Australian and European machinery safety standards and is suitable for application within category 4 safety related parts of control systems. The dual parallel ported manifold valves come in an external pilot solenoid type and air operated type. The materials comprise a main body manifold of aluminium or 316 stainless steel. The extension housing is made of aluminium. The pilot housing and plunger are made of aluminium alloy and the return spring of steel. The seal material is GB-2_{—}2A15A_NBR (Nitrite Rubber)/GB-202C15A_EPR (Ethylene Propylene Rubber). The screws are cap screws and the lubricant comprises diamond grease. The switch is a Bernstein 188-U1Z w (608.6103.008) of the plunger type having approvals: EN 1088, EN 60947-5-1, EN 292, EN 60204-1. There is 1× Normally Closed (Safety Contact)/1× Normally Open (Non Safe Contact). The wiring comprises Switch Terminals: 11-12 White-Black (NC), 21-22 Brown-blue (NO). The coil voltages available comprise; 240 vac, 110 vac, 24 vdc, 12 vdc. The power consumption is 1.8 W having a DIN connector with Indicator light and surge suppression. There is an allowable voltage of −15% to +10% rated voltage and an apparent power AC of inrush: 5.6 VA/50 Hz 5.0 VA/60 Hz. The holding is 3.4 VA (2.1 W) 50 Hz, 2.3 VA (1.5 W) 60 Hz. The plug wiring is Pin 1: Positive/Active; Pin 2: Negative/Neutral; and Earth: Earth. The performance valve working pressure range is 0−1000 kPa with a port connection of ½″ BSP. The medium comprises Air, Water, Ethylene Glycol for EPR seals only. The operating temperature range comprises NBR Max +60 Celsius/EPR+90 Celsius with a Cv (flow factor): P to A 3.0. The Maximum Operating Frequency is 5 Hz and the Deactivation time is 65 Milliseconds. The rating is Protection: IP 65 with Approvals: Low Voltage Directive: File No: R 9250033, EMC Directive: File No: H/EMC 95000251-3 and Machinery Directives: 98/37/EC-EN 292-1, EN 292-2, EN-983, EN 954-1, EN 1050. The Manual Override is Disabled

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

1-38. (canceled)

39. A valve comprising:
a body portion,
a closure portion adapted to control the flow of fluid through the body portion, and
a valve element being disposed proximate the closure portion and the body portion.

40. A valve as claimed in claim 39, wherein the valve element is associated with the valve body portion, a movable portion of the valve and/or a head of the valve.

41. A valve as claimed as claimed in claim 39, wherein the valve is a check valve or a spool valve.

42. A valve as claimed as claimed in claim 39, wherein the closure portion comprises a poppet valve or a closure element adapted to provide a relative sealing engagement with the valve element at least during deadband travel of the valve

43. A valve as claimed as claimed in claim 39, wherein the valve provides for deadband travel.

44. A valve as claimed in claim 43, wherein the valve element has a dimension that substantially defines the amount of deadband travel of the valve.

45. A valve comprising: a valve closure element, and a body having a port, the valve closure element being moveable between two positions relative to the body, and the body providing for a degree of movement of the valve closure element from one of the two positions towards the other of the two positions before fluid readily flows through the port.

46. A valve assembly comprising: a valve closure element, and a body defining a passage having a longitudinal axis and a port in line therewith, the valve closure element being moveable along the longitudinal axis of the passage, between a first and a second position to selectively allow fluid to flow through the port, and the body providing a degree of movement of the valve element from the first position towards the second position before fluid readily flows through the port.

47. A valve assembly as claimed in claim 46, including a switch associated with the valve closure element and adapted to make use of the degree of movement of the valve element from the first position towards the second position before fluid readily flows through the port.

48. A valve accessory adapted to enable limited deadband travel in a valve, the valve having a mount portion and a body portion, the valve accessory comprising: a first portion adapted to cooperate with the mount portion, a second portion adapted to cooperate with the body portion, the valve accessory being further adapted to be located between the body portion and the mount portion.

49. A valve accessory as claimed in claim 48 further comprising a third portion adapted to cooperate with a closure element of the valve.

50. A valve accessory adapted to enable limited deadband travel in a valve, the valve having a body portion, the valve accessory comprising: a first portion adapted to engage an end of the body portion defining a port thereof for cooperating with a closure element of the valve.

51. A valve accessory as claimed in as claim 50, wherein a seal is provided between the first portion of valve accessory and the body portion.

52. A safety method including using deadband travel in a safety system to ensure that a switch is able to safely determine at least one operating condition.

53. A method of configuring a valve assembly to enable deadband travel, the method comprising the steps of:
providing a valve element,
associating the valve element with a portion of the valve, proximate a valve port in a manner which results in a relative thickening of the portion of the valve.

54. A method of configuring a safety valve assembly adapted to be associated with a fluid flow path, the method comprising the steps of:
configuring at least one valve as claimed in claim 39,
operatively coupling at least one of the at least one valves to a switch and a switch actuator.

55. A method as claimed in claim 54 wherein activation of the switch by the switch actuator is provided prior to flow of fluid in the fluid path.

56. A fluid control system comprising a valve as claimed in claim 39.

57. A valve comprising a body having a first portion for seating against a fluid port and second portion for being received within the fluid port when the seat portion is seated against the fluid port, the second portion being configured for providing for dead band travel when the first portion is moved away from the fluid port.

58. A valve as claimed in claim 57 wherein the valve comprises a poppet valve.
